(19) United States
(12) Patent Application Publication
(10) Pub. No.: US 2004/0142070 A1
(43) Pub. Date: Jul. 22, 2004

(54) Changeable medium food package

(76) Inventor: Joshua Haen, Maple Grove, MN (US)

Correspondence Address: GENERAL MILLS, INC., P.O. BOX 1113, MINNEAPOLIS, MN, 55440, US

(21) Appl. No.: 10/346,982

(22) Filed: Jan. 17, 2003

(51) Int. Cl. A23L 1/00

(52) U.S. Cl. 426/87

(57) ABSTRACT

The present invention is directed to a novel consumer package having a changeable medium or image fields as well as other non-changeable medium or imaged fields, wherein the changeable medium or image fields transition from colored to transparent, or a different color at a temperature of about 48° F. (8° C.) to about 59° F. (15° C.). The present invention is directed further to a plurality of at least a first and second design of the novel consumer package having changeable medium and non-changeable medium or imaged fields contained within a rigid container.

### CROSS-REFERENCES TO RELATED APPLICATIONS

None.

### BACKGROUND OF THE INVENTION

Today's marketplace presents the consumer with the daunting task of selecting goods that encompass a broad spectrum of choices. The typical consumer is offered a wide variety of food and other retail packages that are available today in the marketplace, all of which are intended to serve a particular purpose, that of getting a consumer to purchase the particular product, which is contained within the package. While some products may not require any additional marketing initiative or promotional giveaways, other products use such messages and offer “premiums” to encourage the retail shopper to select one package over the other. However, many promotional messages or premiums are not suitable for use with such packaging as the message or premium will come into direct contact with the mouth of the consumer or the food itself, as he or she ingest the contents of the package.

In order to attract consumer attention, such retail packages may take on different geometric shapes to distinguish the offering from other competitive products, may display a particular health message, such as an aid in lowering cholesterol or weight reduction, provide sweepstakes entries and other prize giveaways and the like.

The contents of such retail food products can also take many forms and include a variety of offerings such as cereal, yogurt, beverages, snacks, chips, nuts, sauces and creams, pudding, apple sauce, ice cream, pastes and the like and lend themselves to a virtual myriad of packaging configurations.

Compounding the problems of the manufacturer faced in today's marketplace, consumers demand greater convenience. As our society becomes increasingly mobile, there has been an upsurge in the number and types of food packages that customers can consume “on the go” or when it is otherwise inconvenient for a consumer to sit down and ingest a meal in what society may view as a conventional setting, i.e. sitting around a table. With the creation of such ready to eat (“RTE”) food products and their related packages, a difficulty arises in getting the consumer to notice the specific package in amongst competitive offerings.

Other problems which manufacturer's face result from strict governmental guidelines enacted to protect consumers from potentially hazardous materials found in the packaging. The use of ink, adhesives, resins and the like in packing food products is strictly regulated and in a number of instances, contact between the materials and the food is not permitted. In those few instances that do exist in which labels can be applied directly to the food product (for example, labels on bananas or other fruit), such labels do not readily lend themselves to other food packaging requirements for such ready to eat products or requirements for a particular marketing campaign. For example in packaging sauces, mixes, yogurts and the like an impervious package must be use not to prevent oxidation of the contents, but also premature loss of the product.

Packaging containing glow-in-the dark, temperature-sensitive inks, holographic features and the like have been known and available in the industry for some time and add marketing, safety and play value to a package. However, heretofore changeable medium materials have not been applied to laminated flexible film elongated packaging; otherwise referred to as “stick pack” or tube packaging, wherein the temperature-sensitive ink color change is operable at a temperature of about 48° F.±2° F. (8° C.±2° C.) to about 59° F.±2° F. (15° C.±2° C.).

As such, what is needed is a food package that can be used in delivering a food product in an attractive and competitive fashion while simultaneously over coming the difficulties enumerated above.

### BRIEF SUMMARY OF THE INVENTION

The present invention is directed to a novel package for a consumable food product. The instant application is directed toward a food package having unique and variable printed indicia that coincides with a particular event or promotion. Specifically, the instant application is directed toward a food package having a changeable medium or image fields. More specifically, the instant application is directed generally to the field of temperature-sensitive materials, and more particularly to a flexible film elongated food package containing a temperature-sensitive material capable of transitioning from color-to-color or from color-to-transparent at a temperature range of about 48° F.±2° F. (8° C.±2° C.) to about 59° F.±2° F. (15° C.±2° C.). The food package is printed or coated with a thermochromic material such as ink, coatings, paste, gel, pigments or other substance such as a resin or other thermoplastic materials, that may posses some thermochromic or similar property.

In one embodiment of the present invention, a changeable food package is provided which comprises a laminate having first and second layers and each of the layers are provided with first and second sides. A first region of one of the first and second sides of the first and second layers is receptive to a first printing and the first printing is confined to a first area. A second region of one of the first and second sides of the first and second layers is receptive to a second printing different than the first printing, the second printing is confined to a second area which is distinct from but complimentary to the first area. One of the first and second printings has a thermochromic property operable at a temperature range of about 48° F.±2° F. (8° C.±2° C. to about 59° F.±2° F. (15° C.±2° C.) and the first printing area is substantially confined within the second area. The first and second print areas are changeable, interchangeable, and variable.

In another embodiment of the present invention, a first consumer food package is provided having a relatively rigid structure. A plurality of second elongated containers are provided each having a structure which is less rigid than the first consumer food package, each of the second containers being sized to fit within the first container. The plurality of second containers within the first container having at least first and second designs being composed of at least first and second printable areas; wherein the first printable areas have a changeable medium applied thereto. The changeable medium creating a changeable design when the at least first and second designs of the second containers are subjected to a medium changing event.

These and other objects of the invention will become clear from an inspection of the detailed description of the invention and from the appended claims.

### BRIEF DESCRIPTION OF THE DRAWINGS

The objects and advantages of this invention will be more completely understood and appreciated by referring to the following more detailed description of the presently preferred exemplary embodiments of the invention in conjunction with the accompanying drawings, of which:

FIGS. 1A and 1B is a front view of a novel elongated food package stored at a temperature at or below 48° F.±2° F. (8° C.±2° C.) of the present invention;

FIGS. 2A and 2B is a front view of the novel elongated food package at a temperature above 59° F.±2° F. (15° C.±2° C.);

FIG. 3 is a schematic view of the printing process;

FIG. 4 illustrates a schematic side view of a laminate useful in the present invention; and

FIG. 5 is a perspective view of a rigid consumer food package containing a plurality of less rigid second containers.

### DETAILED DESCRIPTION OF THE INVENTION

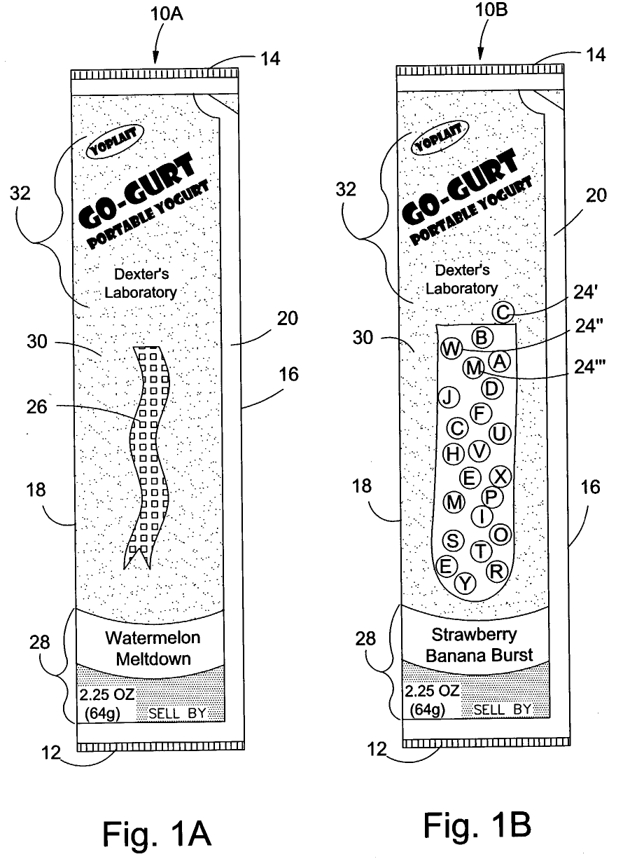

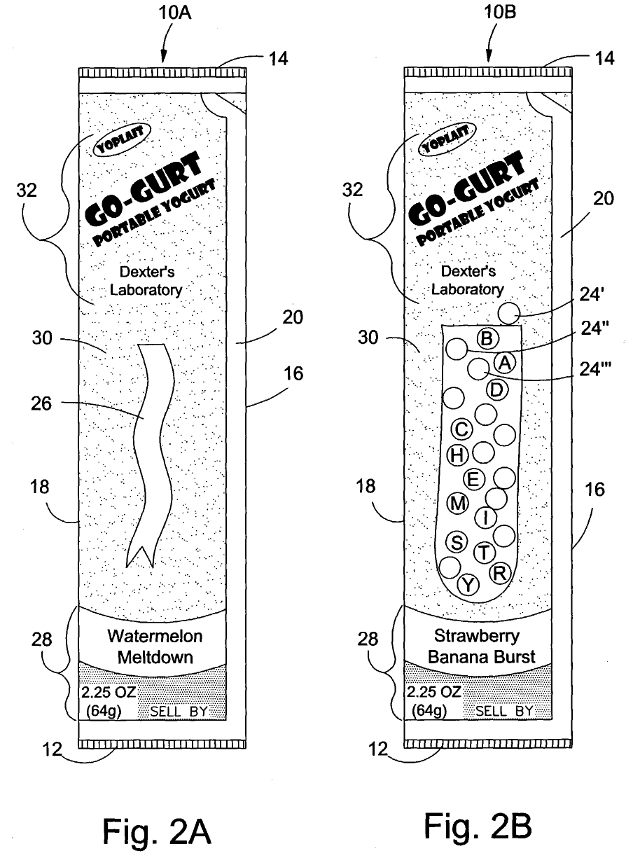

The invention of the instant application is illustrated and depicted generally by the reference to the package 10 in FIGS. 1A, 1B, 2A, and 2B. While the illustration in the present embodiment is directed to a flexible film elongated package usable in providing ready to eat(“RTS”) servings of yogurt, such as those offered under the trademarks GO-GURT® and EXPRESSE® available from General Mills, Inc. of Minneapolis, Minn, the scope and spirit of the invention is not to be so limited. For example, the flexible film elongated package can be usable in providing ready to eat servings of applesauce, pudding, Jell-O, ice cream, and other comestibles.

As used herein, the term package refers to any package which is sold or distributed through a retail or wholesale environment or outlet, such as grocery and convenience stores, warehouse clubs, Internet based grocers, specialty stores and the like. The package can contain food, detergents, personal care products and other products intended for consumption or use.

The package 10 formed from a laminated flexible film is provided with first and second end edges 12 and 14 each of which are sealed after the package has been filled with the contents. Package 10 has first and second longitudinally extending sides 16 and 18, which are disposed perpendicularly in the present embodiment to the end edges 12 and 14. That is, the end edges 12 and 14 extend in a direction which is transverse to the direction of the side edges. The longitudinally extending sides 16 and 18 in the present embodiment are substantially longer than the end edges 12 and 14 creating a substantially elongated quadrate or rectangularly shaped package 10. However, other configurations and shapes are possible, such as a square, circle, triangle, pentagon, hexagon, etc.

The package 10 of the preferred embodiment is constructed of a thermoplastic or heat sealable film such as polyester based films and resin like polyethylene terephthalate (PET). Multiple sheets or layers are bonded, extruded, or spin welded together to create a laminate. The laminate may have different coated surfaces, one of which permits direct contact and another of which may be suitable for receiving printing or imaging. The package 10 is provided with a front panel 20 and a rear panel (not shown), which when sealed along the longitudinal sides 16 and 18, form a closure for a elongated package, also referred to as a “stick pack” or tube.

In a representative embodiment, the front panel 20 is divided up into a number of printing or imaging regions or areas, 24, 26, 28, 30, and 32. While in the present invention, a number of printing or imaging areas or regions have been provided, any number of areas or regions to receive illustrations or indicia can be used to accommodate or compliment the design or marketing campaign.

In manufacturing the present product, up to nine printing stations may be used. As used herein “printing stations” include flexographic, roto gravure, ink jet, ion deposition or other means suitable for printing or applying the medium. In the present embodiment, regions 24 and 26 define printing or imaging regions or areas each of which is provided with an imaging or printing material that is different or distinct from the printing or imaging regions or areas illustrated at 28, 30, and 32, collectively, in essence creating separate printing zones or defined printing regions. In the first printing area or region, the panel is provided with a material, which is a changeable medium. More specifically, the first printing area or region is provided with a material which is temperature-sensitive. The second printing or imaging region or areas depicted by 28, 30, and 32 are provided with a second printing or imaging material which is a non-changeable medium, more particularly a non-temperature sensitive material.

In the first printing area or regions 24 and 26, the panel is provided with a material, which is a changeable medium, such as a temperature-sensitive ink or theremochromic ink, including liquid crystals or leucodyes. An exemplary thermochromic leucodye, as used herein is “DynaColor Thermochromic Water-Based Flexographic” ink available from Chromatic Technologies, Inc., 4320 Northpark Drive, Suite B, Colorado Springs, Colo. 80907-4247.

The thermochromic ink can be applied to the flexible film laminate via a conventional process such as flexographic ink process or other methods available. In its cooled state, a leucodye exhibits color, and when warmed, it turns transparent, translucent, or opaque. It takes a 5-10° F. (3-6° C.) shift to produce a color change. As illustrated in FIGS. 1A and 1B, when the package is at a temperature at or below 48° F.±2° F. (8° C.±2° C.) the first printing area or regions 24 and 26 exhibit a color in the visible spectrum (i.e. blue, red, green, purple). When the package temperature of 48° F.±2° F. (8° C.±2° C.) is reached the first printing area or regions 24 and 26 begin transitioning to transparent. As the package temperature increases further and upon reaching a temperature of 59° F.±2° F. (15° C.±2° C.) the first printing area or regions 24 and 26 become completely transparent, as illustrated in FIGS. 2A. and 2B the printing area or regions 24 and 26 are now transparent, no longer containing visible colored ink or alphanumeric characters. Alternatively, leucodye thermochromic inks can change from one visible color to another such as blue to red, rather than transitioning from colored to colorless. This is achieved with an ink that combines a leucodye with a permanent colored ink formulation. For example, the ink manufacturer can formulate a leucodye such that in its cooled state the ink layer is blue, and once warmed becomes red.

In order to accomplish the objective of increasing sales of a particular product by constructing a package having a promotional or marketing theme, it is one of the objectives of the present invention that the first and second printing areas, defined respectively as 24 and 26 and 28, 30, and 32, are printed or imaged in a manner that is complimentary to that of the other area. That is, the complimentary printing or imaging may comprise shading to “flesh out” or complete the trade dress associated with the character or scene, or it may include additional design elements, such as musical symbols, mythical creatures, ancient texts, etc. In addition, multiple themes can be conveyed to the consumer by only imprinting or imaging adjacent areas of the package 10 so as to create individual zones for each prospective message or pattern.

The printing or imaging provided in the second areas 28, 30, and 32 may comprise alphanumeric characters, geometric shapes such as rectangle, or other depictions of characters or illustrations which make up a particular feature or subject of the promotion surrounding the particular food/product package. For example, if the present invention were used with a cereal product, the character may be LUCKY THE LEPRECHAUN® and complimentary shapes may include the shaped marbits or marshmallow candy pieces found in the cereal LUCKY CHARMS® available from General Mills, Inc., Minneapolis, Minn.

The printing or imaging provided in the second areas depicted by numerical references 28, 30, and 32 may also be provided with alphanumeric imaging or printing as well as background coloration, illustrated in FIGS. 1A and 1B, or other characters, illustrations or geometric shapes which coincide with the particular promotional or marketing effort that coincides with the particular package.

In the illustrations provided in FIGS. 1A and 1B, the particular promotion which is being provided in connection with the package 10 offering is one related to CARTOON NETWORK® an AOL Time Warner Company, and the geometric depiction of printing area 24′, 24″, 24′″ is letters in variable sized fonts contained within some of the “bubbles” located in the “test tube.” The printing area 26 is a pathway with curvature. Printing or imaging areas 30 and 32 are imaged with background colors which may be selected for the promotion or to match the color of the food product provided in the package itself. In the present illustration, printing area 28 is provided with the background color as well as information pertinent to the contents, such as the expiration date and weight of the contents of the package 10. Printing area 30 is imaged with printing, which may change to provide for collectability of the packages or to complement other portions of the promotion or marketing campaign.

The printing that is provided in such areas can be static, that is it remains fixed and unchanging from package to package or alternatively, variable printing or imaging can be provided on each package. Variable printing can be provided by a computer driven ion deposition printer such as available from Xerox Corporation, or through ink jet printers such as those available from Canon Corp. Ltd. Variable printing is accomplished by conventional technologies. By providing variable printing in connection with the packages, the manufacturer can change each package, create sweepstakes or prize notifications or provide other messages that the manufacturer or promoter may wish to deliver to the consumer. In addition, the manufacturer can provide batch and date information, which may differ from package to package.

While the present package 10 has been imaged with a particular character, the present invention is not intended to be so limiting and other characters, animals, scenery or inanimate objects may of course be used.

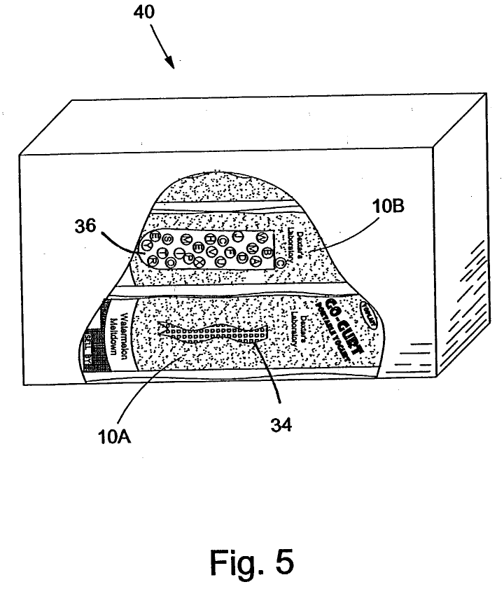

Now referring to FIG. 5. In another embodiment of the present invention, a first consumer food package or container 40 is provided having a relatively rigid structure. Container 40 is sized and configured so as to be able to accommodate a number of single use or RTE packages. A plurality of second elongated packages or containers 10A and 10B are provided each having a structure which is less rigid than the first consumer food package 40, each of the second containers 10A and 10B being sized to fit within the first container 40. The plurality of second containers 10A and 10B within the first container 40 having at least first 34 and second designs 36 being composed of at least first printable areas 24 and 26 (illustrated in FIG. 1) and second printable areas 28, 30, and 32 (illustrated in FIG. 1) printable areas; wherein the first printable areas 24 and 26 have a changeable medium applied thereto and the second printable areas 28, 30, and 32 having a non-changeable medium applied thereto. The changeable medium creating a changeable design when the at least first 34 and second 36 designs of the second containers 10A and 10B are subjected to a medium-changing event, such as a temperature change. The container 40 may also be printed or imaged with indicia that is complimentary to the first 34 and second designs 36 and static field of containers 10A and 10B. Such printing can further illustrate the theme or message being communicated by the manufacturer. Container 20 may be fabricated from any suitable material such as paperboard, fiberboard, cardboard, plastic, etc. so long as it exhibits sufficient rigidity for the intended application.

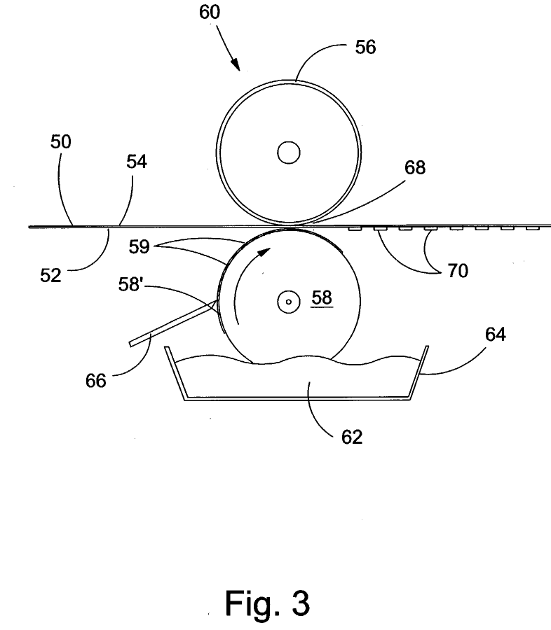

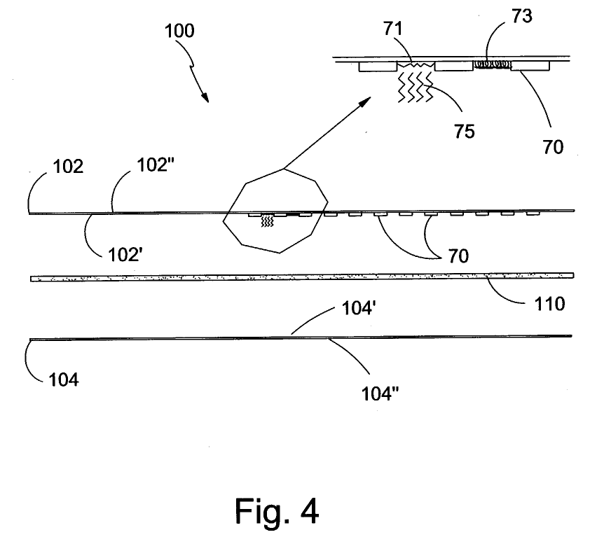

A method which can be utilized to produce a laminate useful in manufacturing the elongated package, also referred to as “stick pack” or tube packaging has been described in part in U.S. Ser. No. 10/062,985 entitled “Visible Light Energy Emitting Laminate For Use In Food Packaging And Method Of Producing” filed on Jan. 31 2002, which is hereby incorporated by reference. Turning now to FIG. 3, which illustrates the manner in which the printing of the laminate 100 (illustrated in FIG. 4) used in the package is accomplished. A polyester resin or film 50 (such as polyethylene terephthalate) has a first surface 52 and a second surface 54. The film 50 may be transparent or translucent or may be provided with areas having transparent or translucent strips to enable the image 70 on surface 102′ (illustrated in FIG. 4) to be viewed on the package. The second surface 54 may be provided with an ink receptive coating so as to bind the ink better to the surface or film 50 may be untreated. The film 50 is advanced to a first printing station depicted generally by reference numeral 60. The printing station 60 includes an impression roller 56 and a printing cylinder 58. The impression roller 56 is provided with a deformable surface, such as a rubber coating or mat, which serves to bias the film into the printing cylinder 58. The printing cylinder 58 is provided with a printing plate 58′. Ink or other imaging material 62 is supplied from a reservoir or fountain 64 directly to the printing plate 58′ and fills depressions 59 in the printing plate 58′. Excess ink is removed through the use of a doctor blade 66 which allows the ink 62 to return to the fountain or reservoir 64. After passing through the nip 68 created between the impression cylinder 56 and the printing cylinder 58 and printing plate 58′ the image 70 is transferred to the film 50 by depressing the film 50 into contact with the depressions 59 in the printing plate 58′.

The image 70 is reverse printed on the film 50 so that it may be viewed through the film 50 which may be transparent or translucent or have strips of transparent or translucent areas depending on the requirements of the packaging or marketing program.

Typically, one color or pattern is applied at the printing station 60 and where additional patterns or designs are provided such as with 24, 26, 28, 30, and 32 additional printing or imaging stations (not shown) are provided. In printing multiple patterns, a drier (not shown) may be used to dry the ink or other imaging material or petroleum based inks are used to expedite the drying process so that the film 50 can enter the next printing station.

The printing or imaging of the film 50 is accomplished in the longitudinal direction of the package 10 parallel to sides 16 and 18. The printing and filling of the package occur in same direction.

With reference to FIG. 4, the laminate, generally depicted by numeral 100 includes at least first and second layers 102 and 104. Layer 102 is composed of a polyester resin or film such as polyethylene terephthalate, which may be transparent or translucent or have portions of the film having these properties. Alternatively, the layer 102 may be mostly opaque if needed. Layer 104, which in the present illustration will be the layer, that is closest to the food contents of the package 10, is typically opaque and may be pigmented with various colors in order to compliment the marketing or promotional campaign. In the present example, the layer is pigmented with a white pigment. The intent is that layer 104 which also may be a thermoplastic film or polyester resin is to create an impervious barrier between the contents of the package 10 and any external material, which is not intended to contact the contents such as printing inks, adhesives, etc. The impervious layer 104 should be both gas and vapor impermeable and may be coated or sealed to achieve the appropriate characteristic. In addition, such pigmentation may serve to highlight the printing or imaging on layer 102.

Each of the layers 102 and 104 have first and second surfaces 102′ and 102″ and 104′ and 104″, respectively. In the illustration provided in FIG. 4, at least one surface of the two layers 102 and 104, here surface 102′ is a printable surface and has received the image 70 which was printed using the process and apparatus discussed above in reference to FIG. 3.

Disposed between the first surface 102 and the second surface 104 is a binder layer 110, which serves to tie or bind the two layers together to form the laminate 100. The binder layer 110 may be composed of adhesive (permanent acrylic, hot melt), a tie coating (such as polyvinyl alcohol) or other suitable medium that will form a permanent bond so that the layers 102 and 104 will not separate one from another after bonding. The image 70 on layer 102′ has first and second printed areas 71 and 73 which may contain different printed patterns such as that illustrated in FIG. 1 on package 10. In the present embodiment, one of the printed areas 71 is printed or imaged with a material, such as a temperature-sensitive ink or resin which will change color 75 after having been exposed to a heat source and achieving an operable color-change in the temperature range of about 48° F.±2° F. (8° C.±2° C.) to about 59° F. ±2° F. (15° C.±2° C.).

The package 10 of the present invention, includes the laminate 100 depicted in FIG. 4. That is, the laminate 100 makes up the exterior panel 20 of the package and the laminate 100 is formed integrally with the package 10. The package 10 may be comprised of the laminate on both the front panel 20 and rear panel (not shown in FIG. 1) and after construction and sealing of the longitudinal sides 16 and 18 is transferred to a filling station using the apparatus referenced above.

The laminate of the present invention has been described as an integral part of the food package, which is suited for the delivery of a flowable product such as yogurt. Such a product is generally known as a tube or “stick pack” and offered under the trademark GOGURT® available from General Mills, Inc., Minneapolis, Minn. However, alternative uses are available for other products which are enclosed in a flexible film that can be stored at refrigeration temperatures, such as cheese, whipped cream, pudding, applesauce, Jell-o, ice cream and the like.

The laminate however can be used or applied directly to a prefabricated package, such as a cereal box, beverage container, baking mix, ready to eat meal containers, dough and biscuit tubs and containers and the like. In such application, one of the exposed surfaces 102″ or 104″ may be provided with an adhesive to secure the laminate to the package. In such a case, the laminate is not formed integrally with the package itself, but rather the laminate is juxtaposed on either external or internal surface of a food or retail package.

It will thus be seen according to the present invention a highly advantageous temperature-sensitive laminate for use with a food package or retail package has been provided, wherein the temperature-sensitive package changes color at an operable temperature of about 48° F.±2° F. (8° C.±2° C.) to about 59° F.±2° F. (15° C.±2° C.). While the invention has been described in connection with what is presently considered to be the most practical and preferred embodiment, it will be apparent to those of ordinary skill in the art that the invention is not to be limited to the disclosed embodiment, that many modifications and equivalent arrangements may be made thereof within the scope of the invention, which scope is to be accorded the broadest interpretation of the appended claims so as to encompass all equivalent structures and products.

What we claim is:

1. A changeable medium food package; comprising,
a consumable food product;
a laminate having at least first and second layers, said laminate being formed into itself to create elongated packages;
a temperature-sensitive material in a first printable area of the laminate;
a non-temperature sensitive material applied to a second printable area of the laminate structure;
a relatively rigid container sized and configured to contain a plurality of the elongated packages, and each of the elongated packages having at least a first and a second design; and
wherein the temperature-sensitive material changes from one color to a second color at a temperature of about 48° F.±2° F. (8° C.±2° C.) to about 59° F.±2° F. (15° C.±2° C.).

2. The food package of claim 1, wherein at least a portion of said second area is imaged with a geometric pattern.

3. The food package of claim 1, wherein at least a portion of said second area is imaged with an illustration of a character.

4. The food package of claim 1, wherein the consumable food product is a yogurt.

5. The food package of claim 1, wherein the consumable food product is apple sauce, pudding, ice cream.

6. The food package of claim 1, wherein said temperature-sensitive material is applied to said first printable area by flexographic, roto gravere, ink jet or a combination thereof.

7. The food package of claim 1, wherein said second printable area background and static information printing.

8. The food package of claim 1, wherein said first printable area includes variably printed information.

9. The food package of claim 1, wherein said second printable area includes variably printed information.

10. A consumer food package, comprising;
a first container having a relatively rigid structure;
a plurality of second containers each having a structure which is less rigid than said first container, each of said second containers being sized and configured to fit within said first container;
at least first and second designs applied to said second containers, each of said first and second designs being composed of at least first and second printable areas;
one of said first and second printable areas having a changeable medium applied thereto; and
wherein said at least first and second designs being applied to said plurality of second containers to create changeable designs when subjected to a medium changing event.

11. The food package of claim 10, wherein said medium changing event is temperature.

12. The food package of claim 10, wherein said changeable medium is thermochromic ink.

13. The food package of claim 10, wherein said changeable medium is thermochromic paste.

14. The food package of claim 10, wherein said changeable medium is thermochromic gel.

15. The food package of claim 10, wherein said changeable medium is thermochromic pigments.

16. The food package of claim 10, wherein said plurality of second containers is formed from a laminate having at least first and second layers.

17. The food package of claim 16, wherein said at least first and second designs is applied to one of said first and second surfaces.

18. The food package of claim 10, wherein said first container is printed with indicia complimentary to said first and second designs.
